(19) United States
(12) Patent Application Publication
(10) Pub. No.: US 2006/0255967 A1
(43) Pub. Date: Nov. 16, 2006

(54) Open road vehicle emissions inspection

(76) Inventors: Henry Sun Yee Woo, Markham (CA); Wai-Cheung Tang, Mannheim (CA); Paul Anthony Laing Manuel, North York (CA); Weimin He, Richmond Hill (CA); Daniel Terrier, Toronto (CA); Roger Tong, Oakville (CA)

Correspondence Address: HANLEY, FLIGHT & ZIMMERMAN, LLC, 20 N. WACKER DRIVE, SUITE 4220, CHICAGO, IL, 60606, US

(21) Appl. No.: 11/409,741

(22) Filed: Apr. 24, 2006

Related U.S. Application Data
(60) Provisional application No. 60/673,764, filed on Apr. 22, 2005.

(51) Int. Cl. G08G 1/065

(52) U.S. Cl. 340/928; 701/29

(57) ABSTRACT

Methods and systems for obtaining vehicle emissions data from on-board vehicle information systems under on-road or open-road conditions. The vehicle may be equipped with a transponder for relaying emissions data to a reader. The reader includes antennas defining a communications zone within a roadway. The transponder and reader are capable of engaging in RF communications as the vehicle-mounted transponder traverses the communications zone.

### CROSS-REFERENCE TO RELATED APPLICATIONS

The present application claims priority to U.S. provisional application Ser. No. 60/673,764 filed Apr. 22, 2005, owned in common herewith, the contents of which are incorporated herein.

### FIELD OF THE INVENTION

The present invention relates to vehicle emissions inspection and, in particular, performing vehicle emissions inspection in an open road environment.

### BACKGROUND OF THE INVENTION

All modern motor vehicles are equipped with on-board computer systems. These vehicle computer systems typically involve one or more computer controllers interconnected with a number of components, systems, and sensors. A data bus is often used to interconnect the various components and computers to facilitate the exchange of information. Such systems also typically provide an access port for obtaining data from the bus, and in some cases placing data on the bus, such as requests for information or instructions to particular components.

Since at least 1996, the United States has required that vehicle manufacturers incorporate on-board emissions diagnostics within the vehicle information systems The standard relevant to light duty automobiles and trucks is referred to as on-board diagnostics (OBD). The standard currently in effect is version OBD-II, with version OBD-III in development

A similar standard applicable to heavy vehicles is the J1708 bus (“J-bus”) and/or J1939 bus.

The vehicle information system is used by service personnel or an emissions inspector to obtain data regarding the vehicle; for example, a mechanic may diagnose problems with the vehicle. Certain trouble codes may trigger a dashboard alert that indicates the user should have the vehicle serviced. A service technician may plug a host computer into the access port (i.e. OBD port) and obtain information from the vehicle information system to diagnose particular problems.

The OBD port may also be used to conduct emissions tests. A vehicle owner attends an emissions test center and a technician plugs a scan tool into the OBD port of a vehicle. Based upon the information obtained, the vehicle may be certified as emissions compliant. The OBD-based emissions testing can replace the traditional tailpipe test.

### SUMMARY OF THE INVENTION

The present invention provides various methods and systems for extracting and communicating on-board vehicle information through wireless transmission and various associated systems and applications

In one aspect, the present invention provides a vehicle emissions testing system for collecting emissions data from vehicles travelling in a roadway. The vehicle has a vehicle information system with an access port, and the vehicle information system provides access to vehicle data including emissions data. The system includes a vehicle-mounted transponder having an input port connected to the access port for extracting the emissions data, and having an RF transceiver and antenna for transmitting the emissions data in response to a request signal. The system also includes a reader disposed proximate the roadway, the reader including a plurality of antennas having radiation patterns defining a capture zone within the roadway. The reader is capable of engaging in RF communications with the transponder when the transponder is within the capture zone, and the reader includes a controller for implementing a communications protocol, including transmission of the request signal and reception of the emissions data.

In another aspect, the present invention provides a method of obtaining emissions data from a vehicle. The vehicle has a transponder with an input port connected to an access port of a vehicle information system within the vehicle. The method includes steps of configuring a roadside reader to implement an emissions data collection protocol, the roadside reader having an antenna defining a communications zone within a roadway, sending an RF signal to the transponder in the communications zone instructing the transponder to obtain the emissions data from the vehicle information system, and receiving an RF response from the transponder containing the emissions data.

In another aspect, the present invention provides a distributed vehicle emissions testing system for collecting emissions data from vehicles travelling in a plurality of roadways. The vehicles each have a vehicle information system with an access port, the vehicle information system provides access to vehicle data including emissions data, and each vehicle has a transponder connected to the access port for extracting emissions data and transmitting the emissions data in an RF signal. The system includes a plurality of readers, each proximate one of said plurality of roadways, each reader including a plurality of antennas defining a capture zone within the roadway. Each reader is capable of engaging in RF communications With the transponder when the transponder is within the capture zone of the reader, and each reader includes a controller for implementing a communications protocol, including transmission of a response signal and reception of the emissions data. The system also includes a central database containing a plurality of emissions records, and a communications network connecting each roadside reader to the central database. Each reader is configured to relay the emissions data to the central database, and the central database is configured to update at least one of said records based upon the emissions data.

Aspects of the present invention include obtaining vehicle information from a vehicle information system wirelessly in an open-road environment, and a system for performing both ETC functions and vehicle information extraction in an open road environment.

In one aspect, the reader used to scan a vehicle-mounted transponder may be a portable reader.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 diagrammatically shows a vehicle equipped with a vehicle information system;

FIG. 2 shows a plan diagram of an electronic toll collection (ETC) system;

FIG. 3 shows, in block diagram form, one embodiment of a transponder;

FIG. 4 shows, in flowchart form, a method of integrating ETC and a vehicle information system;

FIG. 5 shows a block diagram of an embodiment of a transponder;

FIG. 6 shows, in flowchart form, a method of buffering emissions control data;

FIG. 7 diagrammatically shows a remote emissions control system; and

FIG. 8 shows, in flowchart form, a method for remote monitoring of emissions status of vehicles.

Similar reference numerals are used in different figures to denote similar components.

### DESCRIPTION OF SPECIFIC EMBODIMENTS

Integrated ETC and VIS

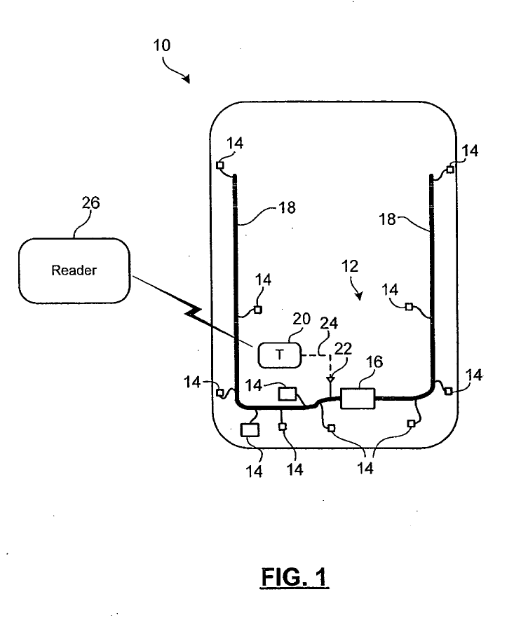

Reference is first made to FIG. 1, which diagrammatically shows a vehicle 10 equipped with a vehicle information system 12. The vehicle information system 12 includes a plurality of devices 14 and a controller 16. The devices 14 may include sensors, servos, microcontrollers, indicators, and any other electrical or electromechanical devices that may be included in a vehicle.

The controller 16 and the devices 14 are interconnected byway of a data bus 18. In some embodiments, the data bus 18 comprises an OBD-compliant bus. In some embodiments, the data bus 18 comprises a J1708 and/or J1939 compliant bus (a “J-bus”). In other embodiments, the data bus 18 complies with another standard. The data bus 18 includes an access port 22.

The vehicle 10 is also equipped with a transponder 20. The transponder 20 comprises an active RF transponder. The transponder 20 includes an interface port for linking the transponder 20 with the data bus 18. The transponder 20 interface port is linked to the access port 22 by way of a short range link 24. The short range link 24 may comprise a wired link or a wireless link. The wireless link may include a Bluetooth™ wireless link. Through the short range link 24, the transponder 20 may obtain data from the data bus 18 and/or write data/commands/requests to the data bus 18.

The transponder 20 communicates with a roadside reader 26 external to the vehicle 10. The reader 26 and transponder 20 communicate by way of RF transmissions. In one embodiment, the RF transmissions between the transponder 20 and the reader 26 use a 915 MHz carrier. In another embodiment, a 5.9 GHz carrier is used. It will be appreciated that other carriers (and possibly subcarriers) may be used. The combination of the roadside reader 26, the transponder 20, and the vehicle information system 12, enables remote host systems or computers to query the vehicle information system 12 while the vehicle 10 is traveling on the road and passing by the reader 26. Information may be obtained remotely from the vehicle information system 12 and may be written to the vehicle information system 12 through the reader 26 and transponder 20. It will be appreciated, that the vehicle 10 need not be in motion for communications to occur between the transponder 20 and the reader 26; the vehicle 10 may be static in the reader's 26 coverage area.

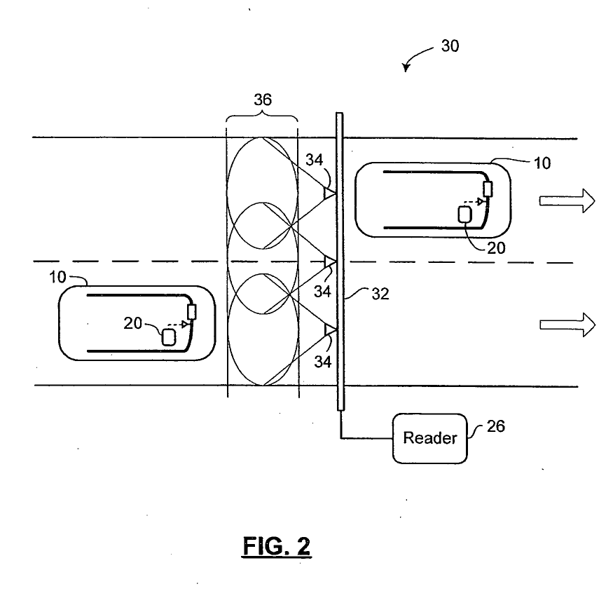

Reference is now made to FIG. 2, which shows a plan diagram of an electronic toll collection (ETC) system 30. The ETC system 30 includes the transponder 20 and reader 26. The transponder 20 is mounted on the vehicle 10 such that its antenna is disposed appropriately to communicate with roadside readers in the ETC system 30. For example, in some embodiments, the transponder 20 may be mounted on the windshield. In some embodiments, the transponder 20 may be mounted on the bumper proximate the license plate area, or upon the roof of the vehicle. In other embodiments, it may be housed within the vehicle body, with an antenna extending out of the vehicle body. The antenna may, in one embodiment, be incorporated into the windshield of the vehicle. Other possible locations for the transponder 20 will be understood by those of ordinary skill in the art.

The ETC system 30 may include a gantry 32 or other structure proximate a roadway. Mounted on the gantry 32 is a plurality of antennae 34. The antennae 34 are connected to and controlled by the reader 26. Each antenna 34 has an effective coverage zone. The collective coverage zones of the antennae 34 define a communication zone 36, within which the reader 26 may communicate with the transponder 20.

The ETC system 30 operates such that as the vehicle 10 enters the communication zone 36 or capture zone (in either an open-road system or a gated system), the reader 26 establishes contact with the transponder 20. For example, the reader 26 may broadcast an interrogation signal. Upon sensing the interrogation signal the transponder 20 may radiate a response signal. The response signal may include a transponder ID code and other information to enable the reader 26 to track the transponder 20 through the communication zone 36. Upon detecting the presence of a transponder 20 in the communication zone 36, the reader 26 then implements a toll transaction protocol. In some embodiments, the reader 26 may calculate a toll amount, may determine whether the transponder 20 has an associated account stored on a remote database and having sufficient credit to pay the toll amount, may debit the account at the remote database, and may send a signal to the transponder 20 confirming the toll amount and the fact that it has been paid.

The communication zone 36 is typically a short section of roadway designed to accommodate no more than one vehicle per lane at a time. In some embodiments the communication zone 36 may be six to twelve feet in length. It will be appreciated that in an open road environment the ETC communications occur in a short time frame, since vehicles traveling at highway speeds are not within the communication zone 36 for a very lengthy period of time.

Other protocols for conducting ETC transactions may be employed by the ETC system 30. Example ETC systems are described in U.S. Pat. Nos. 6,661,352 and 6,191,705, owned in common with the present application, the contents of which are hereby incorporated by reference.

In this embodiment, the transponder 20 operates in both an ETC mode and a vehicle information mode. In the ETC mode, the transponder 20 conducts ETC transactions with the reader 26 in accordance with the pre-established communication protocol for such transactions. In the vehicle information mode, the transponder 20 enables the reader 26 to obtain information from the data bus 18 and to transmit data, instructions, or requests, to the data bus 18.

The reader 26 may instruct the transponder 20 to enter one of the two modes based upon an instruction signal. The transponder 20 may determine the mode in which to operate based upon the structure, format or content of a transmission from the reader 26. For example, an ETC instruction or request may have a format or code that distinguishes it from a vehicle information instruction or request. In some embodiments the two modes may be complimentary. For example, a vehicle information mode, which may be used for emissions inspection or diagnostic analysis, may have an associated fee or charge for the inspection or diagnosis. Following the vehicle information procedure, the ETC mode may be employed to pay for the vehicle inspection procedure.

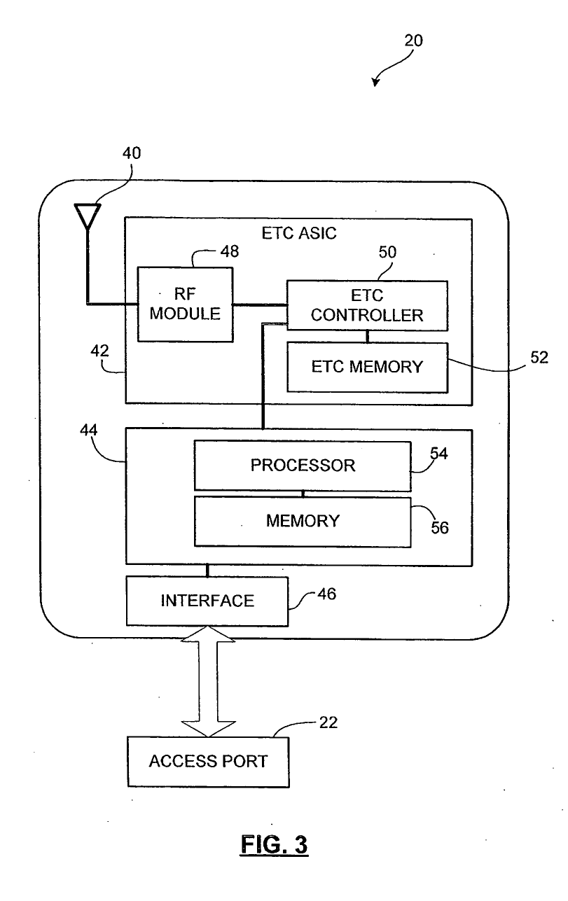

Reference is now made to FIG. 3, which shows, in block diagram form, one embodiment of the transponder 20. The transponder 20 includes an antenna 40, an ETC application-specific integrated circuit (ASIC) 42 and a programmable microcontroller 44. The ASIC 42 includes an RF module 48 for receiving and demodulating RF signals from the antenna 40 and for modulating and transmitting RF signals to the antenna 40. The RF module 48 receives instructions from and provides demodulated signals to an ETC controller 50. The ETC controller 50 is connected to ETC memory 52. The ETC memory 52 may include permanent memory containing stored program control, and may include temporary memory containing transponder information. The transponder information comprises information used to conduct the ETC transactions, and may include such data as last access time, last reader ID, vehicle class, etc. The ETC ASIC 42 is designed for implementing the ETC transaction protocol.

Connected to the ETC ASIC 42 is the microcontroller 44. The microcontroller 44 includes a processor 54 and a memory 56. The processor 54 operates under stored program control to implement the functions and operations described herein. The microcontroller 44 is connected to a port of the ASIC 42 so as monitor communications from the reader 26. Specifically, the microcontroller 44 detects whether the communications from the reader 26 are indicative of ETC-related communications or vehicle information related communications. The reader 26 transmissions may include a code or other indicator signaling whether the transmission relates to an ETC transaction or to vehicle information.

If the microcontroller 44 determines that the reader 26 transmission relates to vehicle information, then it instructs the ETC ASIC 42 to enter a vehicle information mode, wherein the RF module 48 continues to operate normally, but the ETC controller 50 steps aside and control over the operation of the transponder 20 is passed to the microcontroller 44.

The microcontroller 44 then conducts its communications with the reader 26 through the RF module 48 in accordance with a predefined vehicle information communication protocol. The protocol may include receiving requests from the reader 26 for information from the vehicle data bus 18 (FIG. 1), forwarding such requests (formatted as necessary) to the data bus 18 via the access port 22, receiving/reading information from the data bus 18 via the access port 22, and sending the received/read information to the reader 26. The access port 22 is coupled to the microcontroller 44 through an interface 46. In some embodiments, the protocol may also include storing or buffering information from the data bus 18 in the memory 56 prior to transmission to the reader 26, as described further below.

It will be appreciated that the various modules and components of the transponder 20 may be implemented using discrete components or may be further integrated. The microcontroller 44 may be incorporated within another ASIC. A single ASIC may be provided to implement both the ETC and vehicle information modes of operation. Alternatively, one or more microcontrollers may be provided to implement the ETC mode of operation. Various other alternatives will be apparent to those of ordinary skill in the art.

The suitable programming of the microcontroller to implement the described functions and operations will also be within the skill of one of ordinary skill in the art, having regard to the description herein.

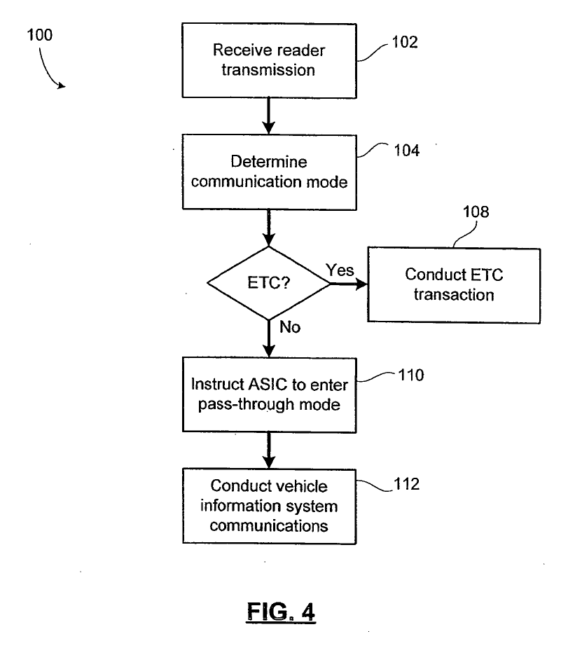

Reference is now made to FIG. 4, which shows, in flowchart form, a method of integrating ETC and a vehicle information system. It will be appreciated that the following method 100 relates to a transponder having an ETC-specific module or ASIC operating in a default ETC mode, but capable of entering a pass-through mode on instruction.

The method 100 begins in step 102 with the receipt by a vehicle-mounted transponder of a reader RF transmission. The reader RF transmission may, for example, be an interrogation signal. The reader RF transmission may alternatively be a subsequent communication sent after the exchange of interrogation and response signals by the reader and transponder to establish communications.

In step 104, the transponder determines whether the received transmission relates to an ETC transaction or to a vehicle information request. The transmission may contain an indicator, such as a numeric code, or may have a distinctive format that enables the transponder to determine whether it relates to ETC or not. If the transmission is ETC-related, then the method 100 continues in step 108. If it is not ETC-related, then the method 100 proceeds to step 110. In step 108, the ETC transaction is conducted in accordance with the appropriate ETC communication protocol. The ETC-specific module or ASIC controls operation of the transponder to complete the transaction.

If the reader transmission is not ETC-related, then in step 110 the ETC-specific module or ASIC is instructed to exit the ETC mode and enter a pass-through mode, wherein any communications from the reader are passed through to the microcontroller configured to interface with the vehicle information system. Communications generated by the microcontroller for transmission to the reader are passed to the RF module for excitation of the antenna. In step 112, the vehicle information exchange is controlled and conducted by the microcontroller in communication with the reader and the data bus.

It will be appreciated, that the foregoing method 100 may by modified or adapted to a different hardware configuration within the transponder. For example, in some embodiments the transponder may operate in a default vehicle information mode and may be instructed to enter an ETC mode when an ETC communication is detected. In some embodiments, the RF module may not be incorporated within the ETC-portion of the transponder and may include a routing module for determining whether to send communications to an ETC module or a vehicle information module. Other modifications or variations will be understood by those skilled in the art.

Integrating an ETC transponder with a vehicle information system allows for greater exploitation of the existing roadside ETC infrastructure for a wider range of applications. It may further motivate wider deployment of ETC-capable infrastructure given the wider range of applications. Applications for remote on-road access to vehicle information include vehicle-specific emissions testing and certification, emissions data collection and analysis, anti-theft vehicle tracking, weigh station bypass, vehicle safety inspection and monitoring, road condition profiling, and any other application that may benefit from roadway access to on-board vehicle information.

In one embodiment, the reader may be a portable and/or handheld reader. A handheld reader and methods of reading transponders using such a reader are described in U.S. patent application Ser. No. 10/439,641 owned in common herewith, the contents of which are hereby incorporated by reference.

VIS Buffering

Existing vehicle information systems, like OBD-II or J-bus, operate over a data bus for interconnecting various sensors, servos, and other electrical or electromechanical devices with a controller. The data buses are used for a variety of purposes. The protocols for these systems may establish a hierarchy of priorities. Higher priority data or devices may enjoy greater access to the bus than lower priority data or devices. For example, emissions control data is considered lower priority data. As a result, when a vehicle owner attends a service station to have an emissions test performed, there can be a significant delay before the service station is able to access emissions data from the data bus. In addition, many emissions tests require data collected while the vehicle is operating under certain conditions.

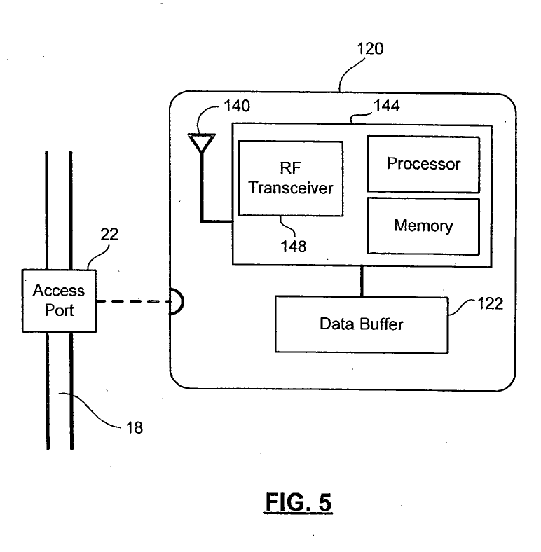

Reference is made to FIG. 5, which shows a block diagram of an embodiment of a transponder 120. The transponder 120 is connected to the access port 22 of the vehicle information data bus 18. The transponder includes an antenna 140 and a microcontroller 144. In this embodiment, the microcontroller 144 implements an RF transceiver module 148.

To speed up emissions testing and to facilitate open road emissions testing, the transponder 120 includes a data buffer 122. The data buffer 122 is configured to capture/mirror data appearing on the bus 18 relating to one or more selected codes. For example, the data buffer 122 may collect information regarding emissions as it appears on the bus 18. Updated information may overwrite previously collected information; or the information may be collected in addition to previous information to provide a historical picture, depending on the application desired.

In another embodiment, the microcontroller 144 actively polls or queries one or more devices on the data bus 18 on a random or periodic basis in order to collect information for storage in the data buffer 122.

In one embodiment, the storage of data in the data buffer 122 is not continuous or ongoing, but is triggered on request. For example, a communication from a roadside reader 26 (FIG. 1) may instruct the transponder 120 to begin accumulating data. Alternatively, the transponder 120 may include a button, switch, or other user input device that, when activated, instructs the transponder 120 to being accumulating data in the data buffer 122. When next queried for emissions information, the transponder 120 reads the information from the data buffer 122 and sends it to the reader 26.

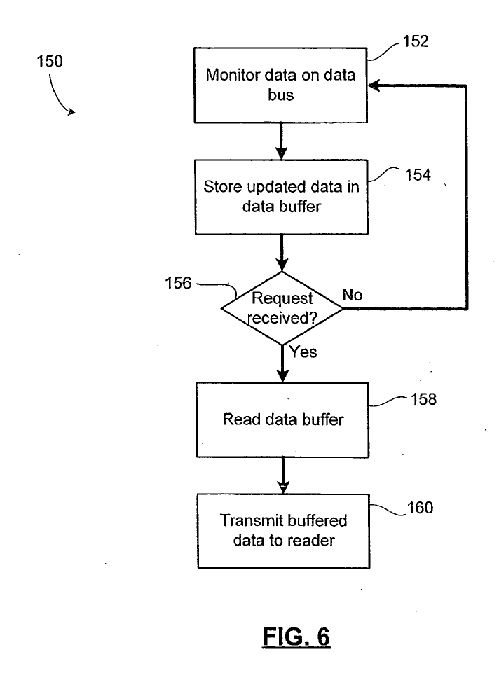

Reference is now made to FIG. 6, which shows, in flowchart form, a method 150 of buffering emissions control data. The method 150 starts in step 152 with the collection of data from the data bus. As discussed above, the data may be provided by a device to the transponder in response to a request from the transponder. Alternatively, the transponder monitors the data bus for the presence of relevant data without specifically requesting it. In any event, the transponder stores the newly found data in the data buffer in step 154. This may include adding the data to previously collected data or updating previously collected data by overwriting the old data with up-to-date data.

In step 156, the transponder evaluates whether it has received a request for emissions data from a reader 26. If not, then it cycles back to step 152 to continue accumulating data. If so, then in step 158 it reads the data buffer and in step 160 it transmits the data in the data buffer to the reader.

It will be appreciated that the data buffer 122 may be used to store data from the data bus 18 relating to other measures besides emissions control.

On-Road Emissions Testing

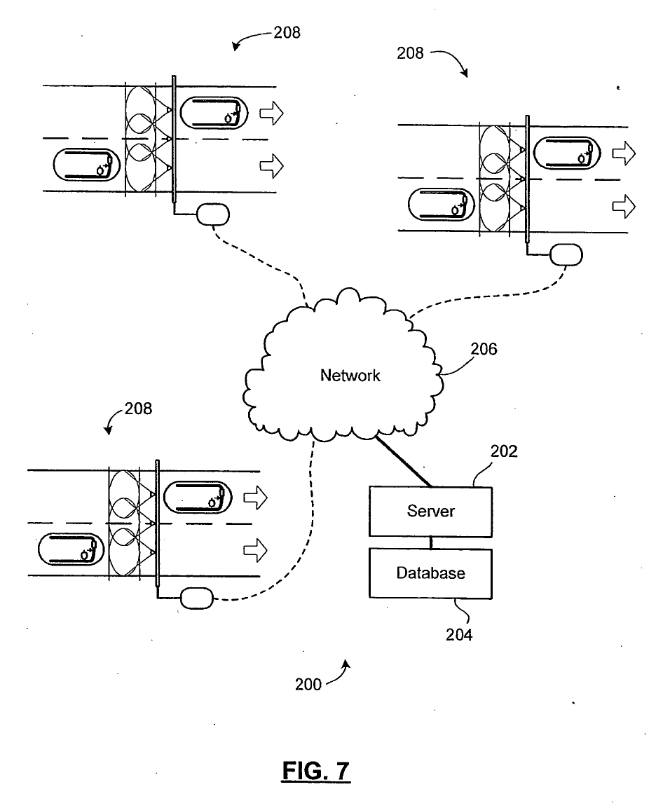

Reference is now made to FIG. 7, which diagrammatically shows a remote emissions control system 200. The remote emissions control system 200 includes a central server 202 and database 204, wherein the central server 202 runs an emissions control monitoring and enforcement program. The database 204 stores information regarding individual vehicles and the emissions test(s) associated with such vehicles.

The central server 202 is connected to a plurality of road-side emissions test systems 208 through a wide area network 206. The network 206 may include private and/or public networks or a combination thereof. The emissions test systems 208 include roadside readers 26 (FIG. 1) and associated equipment for communicating with vehicles in a roadway. In one embodiment, the emissions test system 208 comprise ETC toll equipment, including roadside readers and antennas. The ETC toll antennas define a communication zone within the adjacent roadway within which transponder may engage in RF communications with the roadside reader. The use of the ETC toll equipment leverages existing toll infrastructure to implement the open road emissions testing or verification. It also provides advantages in localizing the emissions data gathering and/or enforcement, since the ETC roadside systems are specific to a short section of roadway and are typically equipped with enforcement mechanisms. It will be appreciated that in some embodiments, separate reader equipment dedicated to conducting emissions testing may be deployed. In either case, the reader is configured to implement an emissions data communications protocol.

The emissions test systems 208 obtain emissions information from the vehicle information systems of individual vehicles on the associated roadway and sends it to the central server 202. The emissions test systems 208 may obtain vehicle identification information along with emissions information so that the emissions information can be associated with a particular vehicle. The vehicle identification information may include, for example, a vehicle identification number (VIN), a license plate number, and/or a vehicle owner name.

The remote emissions control system 200 may be used to verify the data stored in the database 204. The verification may allow for the validation of emissions control status and/or the detection of tampering or fraud. For example, if a vehicle in a roadway is detected to have an emissions fault, i.e. the vehicle MIL light is illuminated, and the database 204 indicates that the vehicle may have recently passed an emissions test, then it may be indicative of tampering with the vehicle in order to temporarily provide sufficient positive data to pass the emissions test.

The remote emissions control system 200 may also be used to certify tested vehicles as compliant. If a vehicle passes through an emissions test system 208 and provides vehicle information indicative of a pass condition, then the vehicle owner may be notified that the vehicle is emissions compliant. Notification could be send by mail, e-mail, or otherwise. The owner would therefore not need to take the vehicle to a test centre when renewing his or her vehicle registration.

Existing ETC systems have mechanisms for associating ETC information with individual vehicles. These mechanisms may be advantageously employed to associate emissions information with a particular vehicle in the roadway for enforcement or validation purposes. For example, U.S. Pat. No. 6,219,613 owned in common herewith describes a mechanism for determining the position of a vehicle in an ETC system. The contents of U.S. Pat. No. 6,219, 613 are hereby incorporated by reference.

The remote emissions control system 200 may be used for statistical data gathering and/or testing. For example, the remote emissions control system 200 may collect emissions data for a roadway. This data may be compared with data collected from other geographic locations. Data may be associated with particular makes or models of vehicle.

In one embodiment, if the remote emissions control system 200 detects an emissions control problem with a vehicle, then it triggers issuance of a notice to the vehicle owner that the emissions control problem must be investigated and repaired. In some embodiments, if the problem is detected again after a preset period (say, one or two months) from the notice, then fines or other enforcement mechanisms may be applied.

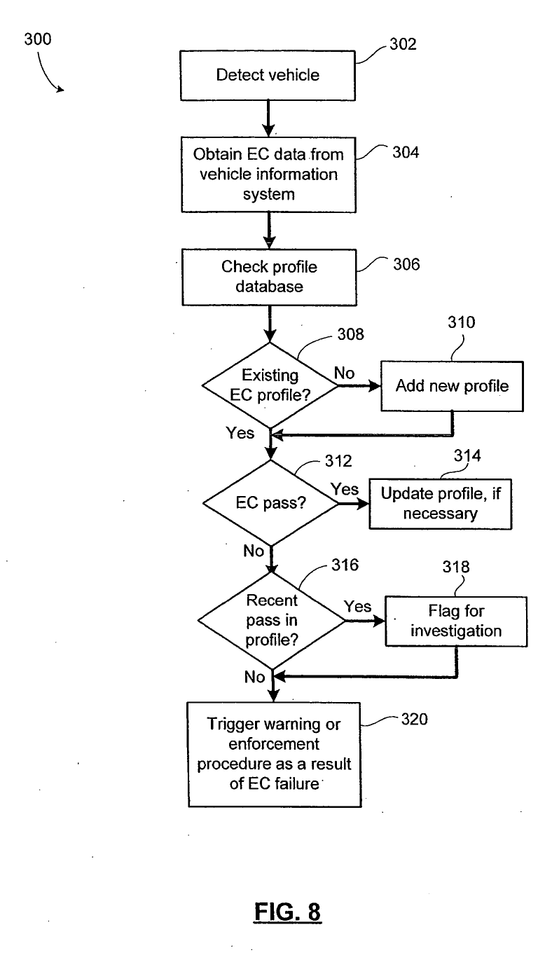

Reference is made to FIG. 8, which shows, in flowchart form, a method 300 for remote monitoring of emissions status of vehicles. The method 300 begins in step 302 with detection of the vehicle in a communications zone of an emissions control system 208 (FIG. 7). In step 304, emissions control data is obtained from the vehicle information system through RF communications with an on-board transponder that relays information from the vehicle information system to a roadside reader. The emissions control data includes a vehicle identifier, such as a VIN number. The emissions control data is sent by the emissions control system 208 to the central server 202 (FIG. 7).

In step 306, the central server 202 queries the database 204 (FIG. 7) to determine if an emissions control profile exists for the vehicle identified by the emissions control system 208. In step 308, the central server 202 determines whether there is an existing emissions control profile for the vehicle. If not, then the collected emissions control data may be used to generate a new profile for the vehicle, which is stored in the database in step 310.

In step 312, the central server 202 evaluates whether the emissions control data indicates that the vehicle has passed. If so, then in step 314 it may update the vehicle profile stored in the database. If not, then the method 300 continues to step 316, wherein the central server 202 may determine whether the profile stored in the database indicates a recent pass of an emissions test. If so, then the server 202 may flag the vehicle as a potential tampering or fraud situation requiring further analysis or investigation.

In step 320, as a result of the emissions failure detected in the emissions control data, the central server 202 may trigger a notification and/or enforcement process. For example, the vehicle owner may be sent a notice regarding the failed test and the requirement to repair the vehicle. Repeated failures may result in imposition of a fine or other enforcement measures.

Encryption and Security

It will be appreciated that the remote and transparent open road collection of vehicle information, including a VIN number, may raise privacy concerns. Accordingly, the transponder may implement an encryption scheme to encrypt any data broadcast to a roadside reader. Moreover, before sending any data to a roadside reader, the transponder may require authentication of the reader identity. Various encryption and/or authentication schemes may be implemented. Those schemes compatible with the RF communication protocols, bandwidth limitations, processing capabilities, and time limitations of a particular implementation will be understood by those of ordinary skill in the art.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A vehicle emissions testing system for collecting emissions data from vehicles travelling in a roadway, the vehicle having a vehicle information system with an access port, the vehicle information system providing access to vehicle data including emissions data, the system comprising:
a vehicle-mounted transponder having an input port connected to the access port for extracting the emissions data, and having an RF transceiver and antenna for transmitting the emissions data in response to a request signal; and
a reader disposed proximate the roadway, the reader including a plurality of antennas having radiation patterns defining a capture zone within the roadway, wherein the reader is capable of engaging in RF communications with the transponder when the transponder is within the capture zone, and wherein the reader includes a controller for implementing a communications protocol, including transmission of the request signal and reception of the emissions data.

2. The vehicle emissions testing system claimed in claim 1, wherein said system comprises an open-road system wherein said controller for implementing said communications protocol is configured to conduct RF communications with the transponder as it traverses the capture zone at highway speed.

3. The vehicle emissions testing system claimed in claim 2, wherein said controller further implements an electronic toll collection protocol for conducting toll transactions with toll transponders within said capture zone.

4. The vehicle emissions testing system claimed in claim 2, wherein said transponder further includes an ETC module implementing an ETC communications protocol via said RF transceiver for conducting toll transactions with an ETC reader.

5. The vehicle emissions testing system claimed in claim 1, further including a central database connected to said reader via one or more communication networks, and wherein said controller is configured to relay said emissions data to said central database over said one or more communications networks.

6. The vehicle emissions testing system claimed in claim 5, wherein said central database includes a plurality of vehicle emissions records, each record including a vehicle identifier and a vehicle emissions status, and wherein said central database updates at least one of said records based upon the emissions data relayed by said controller.

7. The vehicle emissions testing system claimed in claim 6, wherein said central database includes a fraud detection module for detecting possible fraud by comparing the emissions data to one of said records corresponding to the same vehicle.

8. The vehicle emissions testing system claimed in claim 5, wherein said central database includes a plurality of records and wherein said central database is configured to identify one of said records corresponding to the emissions data relayed by said controller, and wherein said central database is configured to issue a notice to a vehicle owner identified by said one of said records.

9. The vehicle emissions testing system claimed in claim 1, wherein said transponder further includes a buffer memory for buffering the emissions data before transmitting the emissions data to the reader.

10. The vehicle emissions testing system claimed in claim 1, wherein said reader further includes a position determination system for identifying the position of the vehicle within a multilane roadway.

11. A method of obtaining emissions data from a vehicle, the vehicle having a transponder, the transponder having an input port connected to an access port of a vehicle information system within the vehicle, the method comprising the steps of:
configuring a roadside reader to implement an emissions data collection protocol, the roadside reader having an antenna defining a communications zone within a roadway;
sending an RF signal to the transponder in the communications zone instructing the transponder to obtain the emissions data from the vehicle information system; and
receiving an RF response from the transponder containing the emissions data.

12. The method claimed in claim 11, wherein said communications zone comprises an open road communications zone, whereby the vehicle traverses the communications zone at a travelling speed.

13. The method claimed in claim 12, wherein the RF signal includes a protocol indicator, and further including a step, performed by the transponder, of determining whether the RF signal relates to an electronic toll collection transaction or to the emissions data collection.

14. The method claimed in claim 11, further including a step of relaying the emissions data from the roadside reader to a central database over a communications network.

15. The method claimed in claim 14, wherein said central database includes a plurality of vehicle emissions records, each record including a vehicle identifier and a vehicle emissions status, and wherein said method includes a step of updating at least one of said records based upon the emissions data.

16. The method claimed in claim 14, wherein said central database includes a plurality of vehicle emissions records, each record including a vehicle identifier and a vehicle emissions status, and wherein said method includes a step of comparing at least one of said record with the emissions data to determine whether fraud is likely.

17. The method claimed in claim 14, wherein said central database includes a plurality of records and wherein said method includes steps of identifying one of said records corresponding to the emissions data and issuing a notice to a vehicle owner identified by said one of said records.

18. The method claimed in claim 11, further including a step of buffing the emissions data in a buffer memory in the transponder prior to said step of receiving.

19. The method claimed in claim 11, wherein the roadside reader includes a plurality of antennas and wherein the method further includes a step of determining a position of the vehicle within the roadway based upon a count of signals received by each of said plurality of antennas from the transponder.

20. A distributed vehicle emissions testing system for collecting emissions data from vehicles travelling in a plurality of roadways, the vehicles each having a vehicle information system with an access port, the vehicle information system providing access to vehicle data including emissions data, and each vehicle having a transponder connected to the access port for extracting emissions data and transmitting the emissions data in an RF signal, the system comprising:
a plurality of readers, each proximate one of said plurality of roadways, each reader including a plurality of antennas defining a capture zone within the roadway, wherein each reader is capable of engaging in RF communications with the transponder when the transponder is within the capture zone of the reader, and wherein the reader includes a controller for implementing a communications protocol, including transmission of a response signal and reception of the emissions data;
a central database containing a plurality of emissions records; and
a communications network connecting each roadside reader to the central database,
wherein each reader is configured to relay the emissions data to the central database, and the central database is configured to update at least one of said records based upon the emissions data.
